(19) United States
(12) Patent Application Publication
(10) Pub. No.: US 2009/0208377 A1
(43) Pub. Date: Aug. 20, 2009

(54) Dissolution test vessel with integrated centering geometry

(75) Inventor: Jeremy Fetvedt, Raleigh, NC (US)

Correspondence Address: Varian Inc.;Legal Department, 3120 Hansen Way D-102, Palo Alto, CA, 94304, US

(73) Assignee: Varian, Inc.

(21) Appl. No.: 12/069,938

(22) Filed: Feb. 14, 2008

(51) Int. Cl. B01L 3/00; B01J 19/00; B23P 11/00

(52) U.S. Cl. 422/102; 422/255; 29/428; 29/525.01

(57) ABSTRACT

A vessel includes a cylindrical section, a bottom section, and a shoulder. The shoulder extends from an outside vessel surface and is concentric with an inside vessel surface relative to a central axis of the vessel. The vessel may be mounted at a dissolution test apparatus by inserting the vessel in an aperture such that the shoulder abuts an inside edge of a vessel support member defining the aperture. The concentric shoulder enables the vessel to be centered in the aperture, or relative to an instrument inserted in the vessel along the central axis. The shoulder may support the vessel at the aperture, or the vessel may include an annular flange above shoulder and the flange may support the vessel.

### CROSS REFERENCE TO RELATED APPLICATIONS

This application is related to the dissolution testing of analyte-containing media as well as following U.S. patent applications titled “Dissolution Test Vessel with Rotational Agitation” and “Captive Evaporation Cover for Dissolution Systems”, which are commonly assigned by the same inventor to the assignee of the present disclosure. These U.S. patent applications are being filed concurrently with the present patent application on Feb. 14, 2008.

### FIELD OF THE INVENTION

The present invention relates generally to dissolution testing of analyte-containing media. More particularly, the present invention relates to the centering and alignment of a vessel utilized to contain dissolution media with respect to an aperture in which the vessel is mounted or an instrument inserted in the vessel

### BACKGROUND OF THE INVENTION

Dissolution testing is often performed as part of preparing and evaluating soluble materials, particularly pharmaceutical dosage forms (e.g., tablets, capsules, and the like) consisting of a therapeutically effective amount of active drug carried by an excipient material. Typically, dosage forms are dropped into test vessels that contain dissolution media of a predetermined volume and chemical composition. For instance, the composition may have a pH factor that emulates a gastro-intestinal environment. Dissolution testing can be useful, for example, in studying the drug release characteristics of the dosage form or in evaluating the quality control of the process used in forming the dose. To ensure validation of the data generated from dissolution-related procedures, dissolution testing is often carried out according to guidelines approved or specified by certain entities such as United States Pharmacopoeia (USP), in which case the testing must be conducted within various parametric ranges. The parameters may include dissolution media temperature, the amount of allowable evaporation-related loss, and the use, position and speed of agitation devices, dosage-retention devices, and other instruments operating in the test vessel.

As a dosage form is dissolving in the test vessel of a dissolution system, optics-based measurements of samples of the solution may be taken at predetermined time intervals through the operation of analytical equipment such as a spectrophotometer. The analytical equipment may determine analyte (e.g. active drug) concentration and/or other properties. The dissolution profile for the dosage form under evaluation—i.e., the percentage of analytes dissolved in the test media at a certain point in time or over a certain period of time—can be calculated from the measurement of analyte concentration in the sample taken. In one specific method employing a spectrophotometer, sometimes referred to as the sipper method, dissolution media samples are pumped from the test vessel(s) to a sample cell contained within the spectrophotometer, scanned while residing in the sample cell, and in some procedures then returned to the test vessel(s). In another more recently developed method, sometimes referred to as the in situ method, a fiber-optic “dip probe” is inserted directly in a test vessel. The dip probe includes one or more optical fibers that communicate with the spectrophotometer. In the in situ technique, the spectrophotometer thus does not require a sample cell as the dip probe serves a similar function. Measurements are taken directly in the test vessel and thus optical signals rather than liquid samples are transported between the test vessel and the spectrophotometer via optical fibers.

The apparatus utilized for carrying out dissolution testing typically includes a vessel plate having an array of apertures into which test vessels are mounted. When the procedure calls for heating the media contained in the vessels, a water bath is often provided underneath the vessel plate such that each vessel is at least partially immersed in the water bath to enable heat transfer from the heated bath to the vessel media. In one exemplary type of test configuration (e.g., USP-NF Apparatus 1), a cylindrical basket is attached to a metallic drive shaft and a pharmaceutical sample is loaded into the basket. One shaft and basket combination is manually or automatically lowered into each test vessel mounted on the vessel plate, and the shaft and basket are caused to rotate. In another type of test configuration (e.g., USP-NF Apparatus 2), a blade-type paddle is attached to each shaft, and the pharmaceutical sample is dropped into each vessel such that it falls to the bottom of the vessel. When proceeding in accordance with the general requirements of Section <711> (Dissolution) of USP24-NF19, each shaft must be positioned in its respective vessel so that its axis is not more than 2 mm at any point from the vertical axis of the vessel.

It is therefore a criterion in certain uses of vessels in which instruments operate that the vessel, and especially its inner surfaces, be aligned concentrically with respect to the instrument. Various approaches have been taken to assist in meeting this criterion.

One approach to vessel centering is disclosed in U.S. Pat. No. 5,403,090, assigned to the assignee of the present disclosure. This patent teaches a vessel aligning structure that locks a standard USP dissolution test vessel into a stable, centered position in a vessel plate relative to a stirring shaft. The vessel is extended through one of the apertures of the vessel plate such that the flanged section of the vessel rests on the top of the vessel plate. In one embodiment, the vessel aligning structure includes an annular ring having a tapered cylindrical section depending downwardly against the inner surface of the vessel, and an annular gasket surrounding the annular ring. When the vessel aligning structure is pressed onto the vessel, the annular gasket is compressed between the vessel aligning structure and the flanged section of the vessel. A mounting receptacle is secured to the vessel plate adjacent to each aperture of the vessel plate. The vessel aligning structure further includes a horizontal bracket arm which slides into the mounting receptacle and is secured by a wing nut and associated threaded stud. In another embodiment, the vessel aligning structure includes a plurality of mounting blocks secured to the vessel plate. One mounting block is positioned over each aperture of the vessel plate. Each mounting block includes a tapered cylindrical section depending downwardly against the inner surface of the vessel. The mounting block has two alignment bores which fit onto corresponding alignment pegs protruding upwardly from the vessel plate.

Another approach to vessel alignment is disclosed in U.S. Pat. No. 5,589,649 in which each aperture of a vessel plate is provided with three alignment fixtures circumferentially spaced in 120-degree intervals around the aperture. Each alignment fixture includes two semi-rigid alignment arms or prongs extending into the area above the aperture. The flanged section of the vessel rests on top of the alignment arms, such that each pair of alignment arms contact the outer surface of the vessel and the vessel is thereby supported by the alignment fixtures. The alignment arms are described as exerting compressive or “symmetrical spring” forces that tend to center the vessel within the aperture of the vessel plate in which the vessel is installed in order to align the vessel with respect to a stirring element.

Another approach to vessel alignment is the EaseAlign™ vessel centering ring commercially available from Varian, Inc., Palo Alto, Calif. The ring is placed onto the flange surrounding the upper opening of the vessel and is secured to posts extending upward from the vessel plate supporting the vessel. The ring includes circumferentially spaced resilient tabs that extend into the interior of the vessel. The tabs include hemispherical protrusions that contact the inside surface of the wall of the vessel. The biasing action of the tabs center the vessel in relation to the fixed position of the posts.

Another approach is disclosed in U.S. Pat. No. 6,562,301, assigned to the assignee of the present disclosure. This patent teaches a two-piece vessel in which an alignment ring is secured around a groove formed on the outside surface of a flange-less vessel. The alignment ring provides a centering interface between the vessel and the aperture wall of the vessel plate in which the vessel is installed. The alignment ring may include an o-ring. Alternatively, circumferentially spaced spring-loaded balls are located between the alignment ring and the aperture wall.

Another approach is disclosed in U.S. Pat. No. 6,673,319, assigned to the assignee of the present disclosure. This patent also teaches a two-piece vessel in which an alignment ring is secured around a groove formed on the outside surface of a flange-less vessel. The alignment ring includes circumferentially spaced magnets that are coupled to corresponding magnets provided with the vessel plate in which the vessel is installed.

Many current vessel centering systems require an unacceptably large footprint around the vessels of a dissolution testing apparatus. As acknowledged by those skilled in the art, a vessel centering system that takes up less area would permit the design of a smaller overall apparatus. The use of a smaller apparatus would be highly desirable in view of the costs associated with building and maintaining pharmaceutical laboratory space.

In addition, many current vessel centering systems require the manipulation of two or more components to account for the often poor and/or inconsistent manufacturing tolerances observed in the wall thickness of the extruded glass tubing from which vessels are formed and in the vessel manufacturing process itself. Glass vessels are typically made by hand from large-bore glass tubing. The glass tubing is placed in a rotating device similar to a lathe, heat is applied, and the tubing is separated and sealed to form a hemispheric or other shaped bottom section. Heat is continually applied while the vessel is blown into the desired shape. This labor-intensive process can result in dimensional irregularities in the finished glass product. Due to hand-forming and the properties of glass, no two dissolution test vessels are exactly alike. While plastic vessels are manufactured with better tolerances since they are fashioned from molds, plastic vessels are generally less desirable in many applications due to drug affinity with the surface and slower heat-up rate.

Accordingly, a continuing need exists for practical and effective solutions to providing a vessel centering system.

### SUMMARY OF THE INVENTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a vessel includes a cylindrical section coaxially disposed about a central axis of the vessel. The cylindrical section includes an inside vessel surface, an outside vessel surface opposing the inside vessel surface, an upper end region circumscribing a vessel opening, and a lower end region axially spaced from the upper end region. A bottom section is disposed at the lower end region. A shoulder is coaxially disposed about the central axis at the upper end region. The shoulder extends radially outward from the outside vessel surface, and includes an outside shoulder surface concentric with the inside vessel surface relative to the central axis.

According to another implementation, a dissolution test apparatus is provided. The dissolution test apparatus includes a vessel support member including a top surface and an inside edge circumscribing an aperture. A vessel extends through the aperture. The vessel includes a cylindrical section, a bottom section, and a shoulder. The cylindrical section is coaxially disposed about a central axis of the vessel. The cylindrical section includes an inside vessel surface, an outside vessel surface opposing the inside vessel surface, an upper end region circumscribing a vessel opening, and a lower end region axially spaced from the upper end region. The bottom section is disposed at the lower end region. The shoulder is coaxially disposed about the central axis at the upper end region. The shoulder extends radially outward from the outside vessel surface and includes an outside shoulder surface concentric with the inside vessel surface relative to the central axis. The outside shoulder surface abuts the inside edge of the aperture, wherein the central axis of the vessel is aligned with a central axis of the aperture.

According to another implementation, an elongated structure extends into the vessel. The outside shoulder surface of the shoulder and the inside vessel surface of the vessel are concentric with the elongated structure.

According to another implementation a method is provided for centering a vessel in an aperture of a vessel support member of a dissolution test apparatus. The vessel is inserted through the aperture. The vessel includes an inside vessel surface, an outside vessel surface and an annular shoulder protruding radially outward from the outside vessel surface. The annular shoulder has an outside shoulder surface that is concentric with the inside vessel surface relative to a central axis of the vessel. The position of the vessel relative to the aperture is fixed at an elevation at which the outside shoulder surface abuts an inside edge of the vessel support member circumscribing the aperture. The central axis of the vessel is aligned with a central axis of the aperture at any polar position relative to the central axis at which the vessel is inserted through the aperture.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view of an example of a dissolution test apparatus with which vessels taught in the present disclosure may be utilized.

FIG. 2 is a perspective view of an example of a vessel according an implementation taught in the present disclosure.

FIG. 3 is an elevation view of the vessel illustrated in FIG. 2.

FIG. 4 is a detailed elevation view of the region of the vessel designated “A” in FIG. 3.

FIG. 5 is a top plan view of the vessel illustrated in FIGS. 2 and 3.

FIG. 6 is a top plan view of a vessel provided with a retention member and a vessel cover according to implementations taught in the present disclosure.

FIG. 7 is a cut-away elevation view of the vessel illustrated in FIG. 6, taken along line “A-A”.

FIG. 8 is a cross-sectional elevation view of a region of another example of a vessel interfacing with a vessel support member according to an implementation taught in the present disclosure.

### DETAILED DESCRIPTION OF THE INVENTION

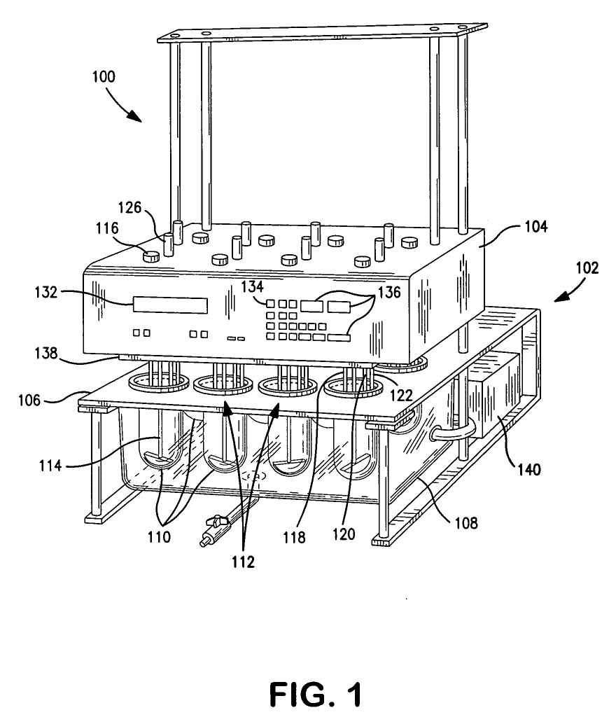

FIG. 1 is a perspective view of an example of a dissolution test apparatus 100 according to an implementation of the present disclosure. The dissolution test apparatus 100 may include a frame assembly 102 supporting various components such as a main housing, control unit or head assembly 104, a vessel support member (e.g., a plate, rack, etc.) 106 below the head assembly 104, and a water bath container 108 below the vessel support member 106. The vessel support member 106 supports a plurality of vessels 110 extending into the interior of the water bath container 108. FIG. 1 illustrates eight vessels 110 by example, but it will be understood that more or less vessels 110 may be provided. The vessels 110 may be centered in place on the vessel support member 106 at a plurality of vessel mounting sites 112 in a manner described in detail below. Vessel covers (not shown) may be provided to prevent loss of media from the vessels 110 due to evaporation, volatility, etc. Optionally, the vessel covers may be coupled to the head assembly 104 and movable by motorized means into position over the upper openings of the vessels 110, as disclosed for example in U.S. Pat. No. 6,962,674, assigned to the assignee of the present disclosure. Water or other suitable heat-carrying liquid medium may be heated and circulated through the water bath container 108 by means such as an external heater and pump module 140, which may be included as part of the dissolution test apparatus 100. Alternatively, the dissolution test apparatus 100 may be a waterless heating design in which each vessel 110 is directly heated by some form of heating element disposed in thermal contact with the wall of the vessel 110, as disclosed for example in U.S. Pat. Nos. 6,303,909 and 6,727,480, assigned to the assignee of the present disclosure.

The head assembly 104 may include mechanisms for operating or controlling various components that operate in the vessels 110 (in situ operative components). For example, the head assembly 104 typically supports stirring elements 114 that include respective motor-driven spindles and paddles operating in each vessel 110. Individual clutches 116 may be provided to alternately engage and disengage power to each stirring element 114 by manual, programmed or automated means. The head assembly 104 also includes mechanisms for driving the rotation of the stirring elements 114. The head assembly 104 may also include mechanisms for operating or controlling media transport cannulas that provide liquid flow paths between liquid lines and corresponding vessels 110. In the present context, the term “between” encompasses a liquid flow path directed from a liquid line into a vessel 110 or a liquid flow path directed from a vessel 110 into a liquid line. Accordingly, the media transport cannulas may include media dispensing cannulas 118 for dispensing media into the vessels 110 and media aspirating cannulas 120 for removing media from the vessels 110. The head assembly 104 may also include mechanisms for operating or controlling other types of in situ operative components 122 such as fiber-optic probes for measuring analyte concentration, temperature sensors, pH detectors, dosage form holders (e.g., USP-type apparatus such as baskets, nets, cylinders, etc.), video cameras, etc. A dosage delivery module 126 may be utilized to preload and drop dosage units (e.g., tablets, capsules, or the like) into selected vessels 110 at prescribed times and media temperatures. Additional examples of mechanisms for operating or controlling various in situ operative components are disclosed for example in above-referenced U.S. Pat. No. 6,962,674.

The head assembly 104 may include a programmable systems control module for controlling the operations of various components of the dissolution test apparatus 100 such as those described above. Peripheral elements may be located on the head assembly 104 such as an LCD display 132 for providing menus, status and other information; a keypad 134 for providing user-inputted operation and control of spindle speed, temperature, test start time, test duration and the like; and readouts 136 for displaying information such as RPM, temperature, elapsed run time, vessel weight and/or volume, or the like.

The dissolution test apparatus 100 may further include one or more movable components for lowering operative components 114, 118, 120, 122 into the vessels 110 and raising operative components 114, 118, 120, 122 out from the vessels 110. The head assembly 104 may itself serve as this movable component. That is, the entire head assembly 104 may be actuated into vertical movement toward and away from the vessel support member 106 by manual, automated or semi-automated means. Alternatively or additionally, other movable components 138 such as a driven platform may be provided to support one or more of the operative components 114, 118, 120, 122 and lower and raise the components 114, 118, 120, 122 relative to the vessels 110 at desired times. One type of movable component may be provided to move one type of operative component (e.g., stirring elements 114) while another type of movable component may be provided to move another type of operative component (e.g., media dispensing cannulas 118 and/or media aspirating cannulas 120). Moreover, a given movable component may include means for separately actuating the movement of a given type of operative component 114, 118, 120, 122. For example, each media dispensing cannula 118 or media aspirating cannula 120 may be movable into and out from its corresponding vessel 110 independently from the other cannulas 118 or 120.

The media dispensing cannulas 118 and the media aspirating cannulas 120 communicate with a pump assembly (not shown) via fluid lines (e.g., conduits, tubing, etc.). The pump assembly may be provided in the head assembly 104 or as a separate module supported elsewhere by the frame 102 of the dissolution test apparatus 100, or as a separate module located external to the frame 102. The pump assembly may include separate pumps for each media dispensing line and/or for each media aspirating line. The pumps may be of any suitable design, one example being the peristaltic type. The media dispensing cannulas 118 and the media aspirating cannulas 120 may constitute the distal end sections of corresponding fluid lines and may have any suitable configuration for dispensing or aspirating liquid (e.g., tubes, hollow probes, nozzles, etc.). In the present context, the term “cannula” simply designates a small liquid conduit of any form that is insertable into a vessel 110.

In a typical operation, each vessel 110 is filled with a predetermined volume of dissolution media by pumping media to the media dispensing cannulas 118 from a suitable media reservoir or other source (not shown). One of the vessels 110 may be utilized as a blank vessel and another as a standard vessel in accordance with known dissolution testing procedures. Dosage units are dropped either manually or automatically into one or more selected media-containing vessels 110, and each stirring element 114 (or other agitation or USP-type device) is rotated within its vessel 110 at a predetermined rate and duration within the test solution as the dosage units dissolve. In other types of tests, a cylindrical basket or cylinder (not shown) loaded with a dosage unit is substituted for each stirring element 114 and rotates or reciprocates within the test solution. For any given vessel 110, the temperature of the media may be maintained at a prescribed temperature (e.g., approximately 37±0.5° C.) if certain USP dissolution methods are being conducted. The mixing speed of the stirring element 114 may also be maintained for similar purposes. Media temperature is maintained by immersion of each vessel 110 in the water bath of water bath container 108, or alternatively by direct heating as described previously. The various operative components 114, 118, 120, 122 provided may operate continuously in the vessels 110 during test runs. Alternatively, the operative components 114, 118, 120, 122 may be lowered manually or by an automated assembly 104 or 138 into the corresponding vessels 110, left to remain in the vessels 110 only while sample measurements are being taken at allotted times, and at all other times kept outside of the media contained in the vessels 110. In some implementations, submerging the operative components 114, 118, 120, 122 in the vessel media at intervals may reduce adverse effects attributed to the presence of the operative components 114, 118, 120, 122 within the vessels 110. During a dissolution test, sample aliquots of media may be pumped from the vessels 110 via the media aspiration cannulas 120 and conducted to an analyzing device (not shown) such as, for example, a spectrophotometer to measure analyte concentration from which dissolution rate data may be generated. In some procedures, the samples taken from the vessels 110 are then returned to the vessels 110 via the media dispensing cannulas 118 or separate media return conduits. Alternatively, sample concentration may be measured directly in the vessels 110 by providing fiber-optic probes as appreciated by persons skilled in the art. After a dissolution test is completed, the media contained in the vessels 110 may be removed via the media aspiration cannulas 120 or separate media removal conduits.

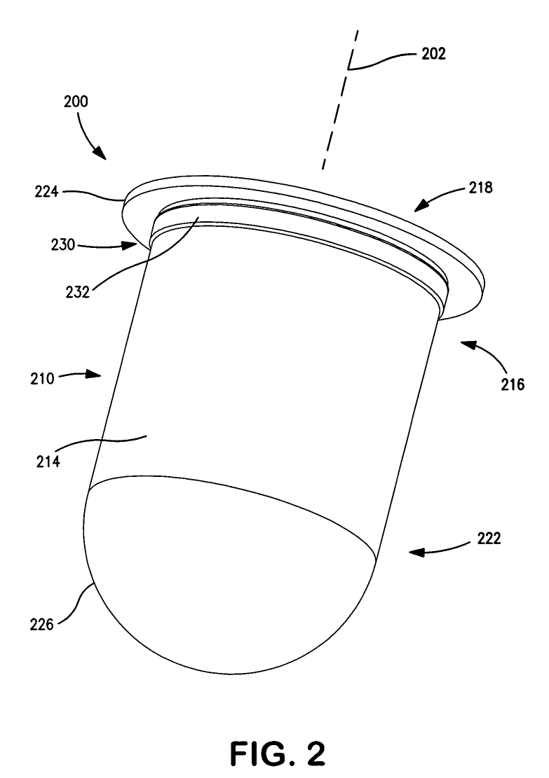

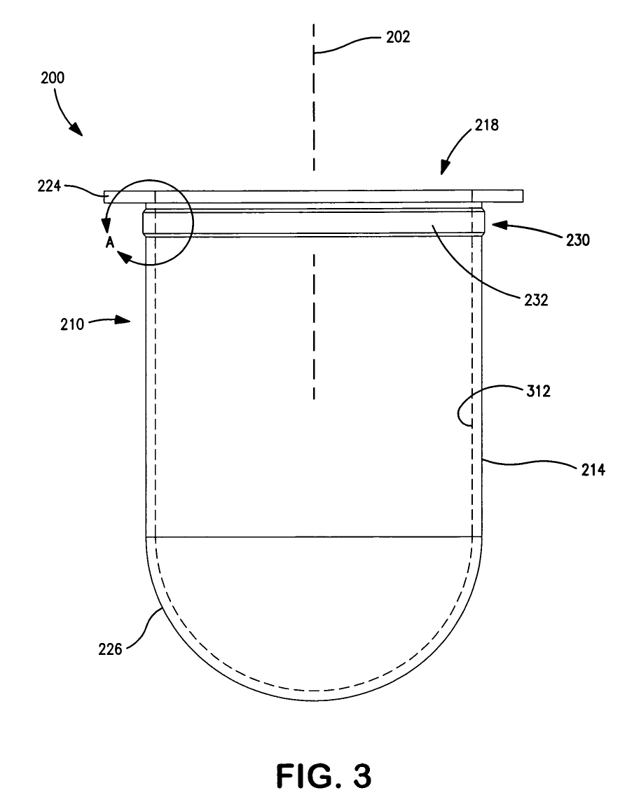

FIGS. 2 and 3 are perspective and elevation views respective of a vessel 200 with integrated centering geometry that may be operatively installed in a dissolution test apparatus such as described above and illustrated in FIG. 1. The vessel 200 is symmetrical about a central axis 202. The vessel 200 includes a cylindrical section 210 coaxially disposed about the central axis 202. The cylindrical section 210 includes an inside surface 312 (FIG. 3) facing the interior of the vessel 200 and an opposing outside surface 214. The cylindrical section 210 also generally includes an upper end region 216 at which the cylindrical section 210 circumscribes an upper opening 218 of the vessel 200, and a lower end region 222 axially spaced from the upper end region 216. The vessel 200 further includes an annular flange 224 that protrudes outwardly from the upper end region 216, typically at or proximate to the upper opening 218. The vessel 200 also includes a bottom section 226 adjoining the cylindrical section 210 at the lower end region 222. The bottom section 226 may be generally hemispherical as illustrated or may have an alternate shape. For example, the bottom section 226 may be flat, dimpled, or have a peak extending upwardly into the interior of the vessel 200.

As also illustrated in FIGS. 2 and 3, the vessel 200 further includes an annular shoulder 230 protruding radially outward from the outside surface 214 of the cylindrical section 210. Relative to the central axis 202, the shoulder 230 is located axially between the flange 224 (or the upper opening 218 of the vessel 200) and the lower end region 222 of the cylindrical section 210. The shoulder 230 includes an outside shoulder surface 232 that faces radially away from the central axis 202. The shoulder 230 is precisely concentric with the inside surface 312 of the vessel 200 relative to the central axis 202.

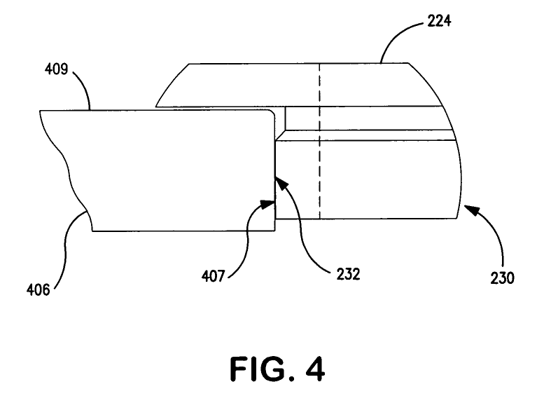

FIG. 4 is a detailed elevation view of the region of the vessel 200 designated A in FIG. 3 that includes the shoulder 230. FIG. 4 also illustrates the interface between the vessel 200 and a vessel support member (or vessel mounting member, or vessel locating member) 406 at which the vessel 200 is mounted. As noted earlier, the vessel support member 406 includes one or more vessel mounting sites at which a like number of vessels may be mounted. At each vessel mounting site, an inside edge or wall 407 of the vessel support member 406 defines an aperture through which the vessel 200 extends. The flange 224 of the vessel 200 extends over a top surface 409 of the vessel support member 406 at the periphery of the aperture. In a typical implementation, the flange 224 rests directly on the vessel support member 406 and thereby supports the weight of the vessel 200 and any liquid contained therein. Alternatively, the vessel 200 may be supported at its bottom section 226 (FIGS. 2 and 3). The concentric outside shoulder surface 232 of the vessel 200 directly abuts the inside edge 407 of the aperture. Due to the uniformity or accuracy of this concentricity, the closeness of the fit between the outside shoulder surface 232 and the inside edge 407 is maintained over the entire circumference of the interface. This configuration ensures that the vessel 200 upon installation is centered in the aperture. No additional components associated with the vessel 200 or the vessel support member 406, or alignment tools or fixtures, are required to center the vessel 200.

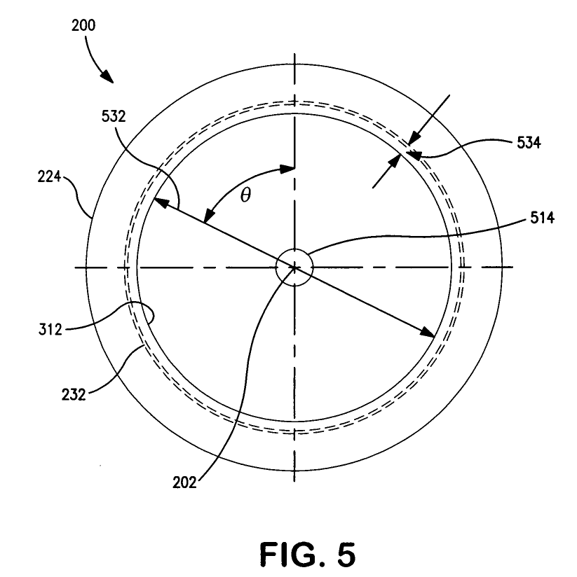

FIG. 5 is a top plan view of the vessel 200 and demonstrates the concentricity of the outside shoulder surface 232 and the inside vessel surface 312. This concentricity is uniform at all circumferential points relative to the central axis 202. That is, as one moves along a reference circumference (for example, the outside shoulder surface 232 or the inside vessel surface 312) at polar angles θ from 0° to 360°, the concentricity is maintained. The uniformity or preciseness of the concentricity ensures that when the vessel 200 is mounted at a vessel plate with a properly dimensioned aperture, the vessel 200 is completely centered at any polar angle. In other words, both the inside vessel surface 312 and the outside shoulder surface 232 are concentric relative to the central axis 202 at any circumferential position at which the vessel 200 may have been installed in the aperture of the vessel plate. The vessel 200 will likewise be centered relative to the aperture of the vessel plate. Stated differently, the central axis 202 of the vessel 200 will be coaxial or collinear with the central axis of the aperture. Moreover, if an elongated structure 514 such as the shaft of an instrument to be operated within the vessel 200 (for example, a paddle- or basket-type instrument) is inserted along the central axis 202 of the vessel 200, the concentricity of both the inside vessel surface 312 and the outside shoulder surface 232 relative to the elongated structure 514 will also be uniform.

One way of expressing the uniformity or preciseness of the above-described concentricity is to consider the diametric difference between the inside diameter of the vessel 200 and the outside diameter of the shoulder 230. In FIG. 5, the inside diameter of the vessel 200 as defined by the inside vessel surface 312 is indicated at 532. The outside shoulder surface 232 defines the outside diameter of the shoulder 230. The diametric difference is indicated at 534. In one example, the diametric difference 534 varies or deviates (i.e., the tolerance) by an amount ±0.05 inch (50 mils) around any referential circumference (i.e., as one moves along polar angles θ from 0° to 360°). In another example, the diametric difference 534 varies by ±0.01 inch (10 mils). In another example, the diametric difference 534 varies by ±0.005 inch (5 mils).

In a typical implementation, the vessel 200 is fabricated from a glass material having a composition suitable for dissolution testing or other analytical techniques as appreciated by persons skilled in the art. In a typical implementation, the shoulder 230 is integrally formed with the cylindrical section 210 of the vessel 200. In one implementation, the shoulder 230 is formed by building up material at the location of the shoulder 230 during fabrication of the vessel 200, and then mounting a lathe or other suitable tool to the vessel 200 such that the cutting element of the lathe can move about the central axis 202 of the vessel 200. The lathe is employed to grind or cut the shoulder material down to form the outside shoulder surface 232 having the desired outside diameter and accurate concentricity with the inside vessel surface 312. Laser inspection or other suitable techniques may be employed to verify the accuracy of the geometry and dimensions of the features of the vessel 200.

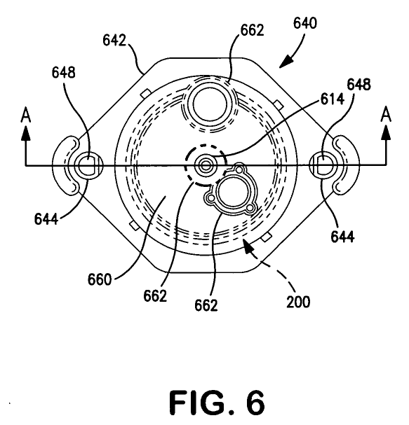

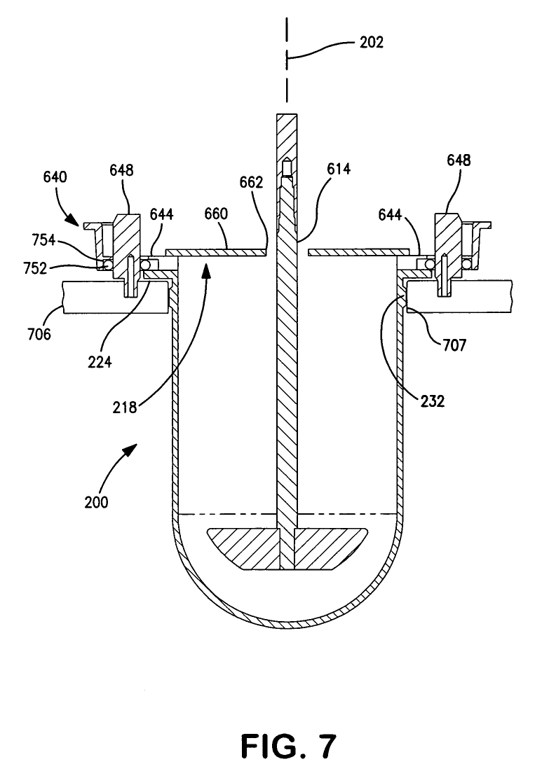

FIG. 6 is a top view of a self-centering vessel 200 as described above. FIG. 7 is a cross-sectional elevation view of the vessel 200 taken along line A-A in FIG. 6. The vessel 200 is mounted at a vessel support member 706 (FIG. 7) at a vertical position at which an inside edge 707 of the vessel support member 706 defining the aperture directly abuts the outside shoulder surface 232 of the vessel. Optionally, a retention member 640 is provided with the vessel 200. The retention member 640 may have any configuration suitable for retaining the vessel 200 in its operative mounted position in the aperture of the vessel support member 706 to prevent the vessel 200 from moving vertically out from the aperture after the vessel 200 has been properly installed. The retention member 640 is therefore particularly useful in conjunction with the use of a liquid bath as described above and illustrated in FIG. 1, as the retention member 640 prevents the vessel 200 from “popping out” of the aperture due to buoyancy effects. In the non-limiting example illustrated in FIGS. 6 and 7, the retention member 640 may include an annular or ring-shaped portion 642 having an aperture coaxial with the central axis 202 of the vessel 200, and one or more holes 644 radially offset from the central axis 202. After lowering a vessel 200 through the aperture of the vessel support member 706, the retention member 640 is lowered onto the flange 224 of the vessel 200 such that posts or pins 648 affixed to the vessel support member 706 extend through the holes 644. O-rings 752 are provided in annular recesses or grooves 754 of the retention member 640 that are aligned with the holes 644 and located between the holes 644 and the flange 224 of the vessel 200. The frictional contact between the o-rings 752 and the pins 648 is sufficient to lock or retain the vessel 200 in place vertically at the vessel mounting site.

FIGS. 6 and 7 also illustrate an optional vessel cover 660 that may be employed to span the upper opening 218 of the vessel 200 to minimize loss of media via evaporation. Such a vessel cover 660 may be supported directly on the flange 224 of the vessel 200. Alternatively, in a case where a retention member 640 is utilized, the vessel cover 660 may be supported by the retention member 640. As shown in FIG. 6, the vessel cover 660 may have one or more apertures 662 to accommodate the use of in situ operative components such as a shaft 614 or other component described earlier in the present disclosure.

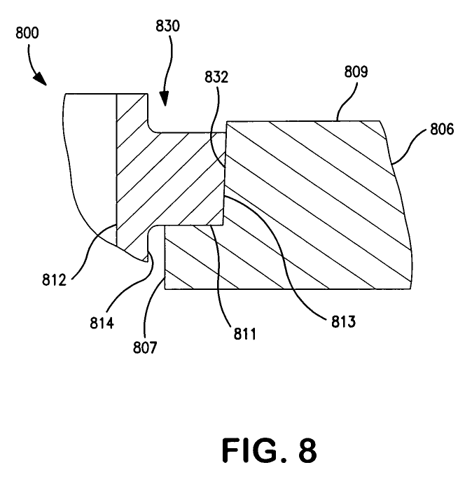

FIG. 8 illustrates another example of a vessel 800 interfacing with a vessel support member 806. In this example, the shoulder 830 supports the vessel 800 in an aperture of the vessel support member 806 defined by an inside edge 807 in a manner that does not require the vessel 800 to include a separate annular flange. In this case, the inside edge 807 may include an area that is recessed relative to a top surface 809 of the vessel support member 806. As an example, the recessed area may include a base or transverse surface 811 adjoining a lateral or axial surface 813. Accordingly, an outside shoulder surface 832 of the shoulder 830 abuts the lateral surface 813 of the inside edge 807. The shoulder 830 may be supported on the base surface 811. Alternatively, the vessel 800 may be supported at its bottom section as previously noted, in which case the base surface 811 need not be provided. The vessel 800 and the vessel support member 806 may in other respects be similar to other examples described elsewhere in the present disclosure, and accordingly like reference numerals designate like features or components.

It will be further understood that various aspects or details of the invention may be changed without departing from the scope of the invention. Furthermore, the foregoing description is for the purpose of illustration only, and not for the purpose of limitation—the invention being defined by the claims.

What is claimed is:

1. A vessel comprising:
a cylindrical section coaxially disposed about a central axis of the vessel, the cylindrical section including an inside vessel surface, an outside vessel surface opposing the inside vessel surface, an upper end region circumscribing a vessel opening, and a lower end region axially spaced from the upper end region;
a bottom section disposed at the lower end region; and
a shoulder coaxially disposed about the central axis at the upper end region, the shoulder extending radially outward from the outside vessel surface and including an outside shoulder surface concentric with the inside vessel surface relative to the central axis, wherein the concentricity of the outside shoulder surface is uniform at any circumferential point relative to the central axis.

2. The vessel of claim 1, wherein the inside vessel surface defines an inside vessel diameter of the cylindrical section, the outside shoulder surface defines an outside shoulder diameter of the shoulder, and the diametric difference between the inside vessel diameter and the outside shoulder diameter is uniform at any circumferential point relative to the central axis.

3. The vessel of claim 1, wherein the inside vessel surface defines an inside vessel diameter of the cylindrical section, the outside shoulder surface defines an outside shoulder diameter of the shoulder, and the diametric difference between the inside vessel diameter and the outside shoulder diameter varies by no greater than ±0.05 inch at any circumferential point relative to the central axis.

4. The vessel of claim 1, wherein the shoulder and the cylindrical section have a glass composition.

5. The vessel of claim 1, wherein the shoulder is integrally formed with the cylindrical section.

6. The vessel of claim 1, further including a flange coaxially disposed about the central axis and radially extending outward from the outside vessel surface at the upper end region, wherein the shoulder is located axially between the flange and the lower end region.

7. A dissolution test apparatus comprising:
a vessel support member including a top surface and an inside edge circumscribing an aperture; and
a vessel extending through the aperture and including:
a cylindrical section coaxially disposed about a central axis of the vessel, the cylindrical section including an inside vessel surface, an outside vessel surface opposing the inside vessel surface, an upper end region circumscribing a vessel opening, and a lower end region axially spaced from the upper end region;
a bottom section disposed at the lower end region; and
a shoulder coaxially disposed about the central axis at the upper end region, the shoulder extending radially outward from the outside vessel surface and including an outside shoulder surface concentric with the inside vessel surface relative to the central axis, the outside shoulder surface abutting the inside edge of the aperture,
wherein the concentricity of the outside shoulder surface is uniform at any circumferential point relative to the central axis, and the central axis of the vessel is aligned with a central axis of the aperture.

8. The dissolution test apparatus of claim 7, wherein the inside vessel surface defines an inside vessel diameter of the cylindrical section, the outside shoulder surface defines an outside shoulder diameter of the shoulder, and the diametric difference between the inside vessel diameter and the outside shoulder diameter is uniform at any circumferential point relative to the central axis.

9. The dissolution test apparatus of claim 7, wherein the inside vessel surface defines an inside vessel diameter of the cylindrical section, the outside shoulder surface defines an outside shoulder diameter of the shoulder, and the diametric difference between the inside vessel diameter and the outside shoulder diameter varies by no greater than ±0.05 inch at any circumferential point relative to the central axis.

10. The dissolution test apparatus of claim 7, further including an elongated structure extending into the vessel, wherein the outside shoulder surface and the inside vessel surface are concentric with the elongated structure.

11. The dissolution test apparatus of claim 7, further including a retention member disposed on the flange and coupled to the vessel support member, wherein the flange is retained between the retention member and the top surface of the vessel support member.

12. The dissolution test apparatus of claim 7, wherein the inside edge circumscribing the aperture includes a base surface disposed below the top surface of the vessel support member, and the shoulder is supported on the base surface.

13. The dissolution test apparatus of claim 7, further including a flange extending over the top surface, the flange coaxially disposed about the central axis and radially extending outward from the outside vessel surface at the upper end region, wherein the shoulder is located axially between the flange and the lower end region.

14. The dissolution test apparatus of claim 7, wherein the vessel is supported at the bottom section.

15. A method for centering a vessel in an aperture of a vessel support member of a dissolution test apparatus, the method comprising:
inserting the vessel through the aperture, the vessel including an inside vessel surface, an outside vessel surface and an annular shoulder protruding radially outward from the outside vessel surface, the annular shoulder having an outside shoulder surface concentric with the inside vessel surface relative to a central axis of the vessel;
fixing the position of the vessel relative to the aperture at an elevation at which the outside shoulder surface abuts an inside edge of the vessel support member circumscribing the aperture, wherein the central axis of the vessel is aligned with a central axis of the aperture at any polar position relative to the central axis at which the vessel is inserted through the aperture.

16. The method of claim 15, further including mounting a retention member on the flange and coupling the retention member with the vessel support member, wherein the flange is retained between the retention member and the top surface of the vessel support member and vertical movement of the vessel relative to the vessel support member is prevented.

17. The method of claim 15, wherein fixing the position of the vessel includes supporting a flange of the vessel on the vessel support member circumscribing the aperture, the flange being coaxially disposed about the central axis and radially extending outward from the outside vessel surface, the shoulder being located axially below the flange.

18. The method of claim 15, wherein fixing the position of the vessel includes supporting the vessel at a bottom section of the vessel.

19. The method of claim 15, further including inserting an elongated structure into the vessel, wherein the outside shoulder surface and the inside vessel surface are concentric with the elongated structure.

20. The method of claim 15, further including introducing a dosage form into the vessel and dissolving the dosage form in the dissolution media and further including transferring at least a portion of the dissolution media from the vessel to an analytical instrument to acquire dissolution data.
